(19) United States
(12) Patent Application Publication
(10) Pub. No.: US 2025/0130168 A1
(43) Pub. Date: Apr. 24, 2025

(54) FLUORESCENCE DETECTION DEVICE

(71) Applicant: Japan Display Inc., Tokyo (JP)

(72) Inventor: Yasuhiro TAKAHASHI, Tokyo (JP)

(73) Assignee: Japan Display Inc., Tokyo (JP)

(21) Appl. No.: 19/007,588

(22) Filed: Jan. 2, 2025

Related U.S. Application Data
(63) Continuation of application No. PCT/JP2023/022483, filed on Jun. 16, 2023.

(30) Foreign Application Priority Data
Jul. 7, 2022 (JP) 2022-110064

(51) Int. Cl. G01N 21/64

(52) U.S. Cl. CPC G01N 21/6456; G01N 2021/6463

(57) ABSTRACT

A fluorescence detection device that has higher detection sensitivity for fluorescence is provided. The fluorescence detection device includes: a light source configured to irradiate a sample with excitation light in a circularly polarized state; a cholesteric liquid crystal layer configured to cause fluorescence emitted by the sample due to the excitation light to transmit therethrough and reflect the excitation light; and detection circuitry configured to detect the fluorescence transmitted through the cholesteric liquid crystal layer.

### CROSS-REFERENCE TO RELATED APPLICATIONS

This application is a continuation of International Patent Application No. PCT/JP2023/022483 filed on Jun. 16, 2023, which claims the benefit of priority from Japanese Patent Application No. 2022-110064 filed on Jul. 7, 2022, the entire contents of each are incorporated herein by reference.

### BACKGROUND

### 1. Technical Field

The present disclosure relates to a fluorescence detection device.

### 2. Description of the Related Art

The fluorescence detection device described in Japanese Patent Application Laid-open Publication No. 2005-321753 (JP-A-2005-321753) includes an optical system with a dichroic mirror and detects fluorescence reflected from a sample.

The fluorescence detection device described in JP-A-2005-321753 is required to achieve higher performance in removing excitation light without a dichroic mirror.

For the foregoing reasons, there is a need for providing a fluorescence detection device that has higher detection sensitivity for fluorescence.

### SUMMARY

According to an aspect of the present disclosure, a fluorescence detection device includes: a light source configured to irradiate a sample with excitation light in a circularly polarized state; a cholesteric liquid crystal layer configured to cause fluorescence emitted by the sample due to the excitation light to transmit therethrough and reflect the excitation light; and detection circuitry configured to detect the fluorescence transmitted through the cholesteric liquid crystal layer.

### BRIEF DESCRIPTION OF THE DRAWINGS

FIG. 1 is a schematic of a fluorescence detection device according to a first embodiment;

FIG. 2 is a sectional view schematically illustrating a cholesteric liquid crystal layer according to the first embodiment;

FIG. 3 is a plan view schematically illustrating a first layer and a seventh layer of the cholesteric liquid crystal layer according to the first embodiment;

FIG. 4 is a plan view schematically illustrating a second layer of the cholesteric liquid crystal layer according to the first embodiment;

FIG. 5 is a plan view schematically illustrating a third layer of the cholesteric liquid crystal layer according to the first embodiment;

FIG. 6 is a plan view schematically illustrating a fourth layer of the cholesteric liquid crystal layer according to the first embodiment;

FIG. 7 is a plan view schematically illustrating a fifth layer of the cholesteric liquid crystal layer according to the first embodiment;

FIG. 8 is a plan view schematically illustrating a sixth layer of the cholesteric liquid crystal layer according to the first embodiment;

FIG. 9 is a diagram for explaining the relation between excitation light and reflected light;

FIG. 10 is a schematic of the fluorescence detection device according to a comparative example;

FIG. 11 is a schematic of the fluorescence detection device according to a second embodiment;

FIG. 12 is a schematic of the fluorescence detection device according to a third embodiment;

FIG. 13 is a schematic of the fluorescence detection device according to a fourth embodiment; and

FIG. 14 is a diagram for explaining the relation between the wavelength characteristics of excitation light reflected by a first liquid crystal layer and the wavelength characteristics of excitation light reflected by a second liquid crystal layer according to the fourth embodiment.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by a person skilled in the art and components substantially identical therewith. Furthermore, the components described below can be appropriately combined. What is disclosed herein is given by way of example only, and appropriate changes made without departing from the spirit of the present disclosure and easily conceivable by a person skilled in the art naturally fall within the scope of the disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by like reference numerals, and detailed explanation thereof may be appropriately omitted.

When the term “on” is used to describe an aspect where a first structure is disposed on a second structure in the present specification and the claims, it includes both of the following cases unless otherwise noted: a case where the first structure is disposed directly on and in contact with the second structure, and a case where the first structure is disposed on the second structure with another structure interposed therebetween.

### First Embodiment

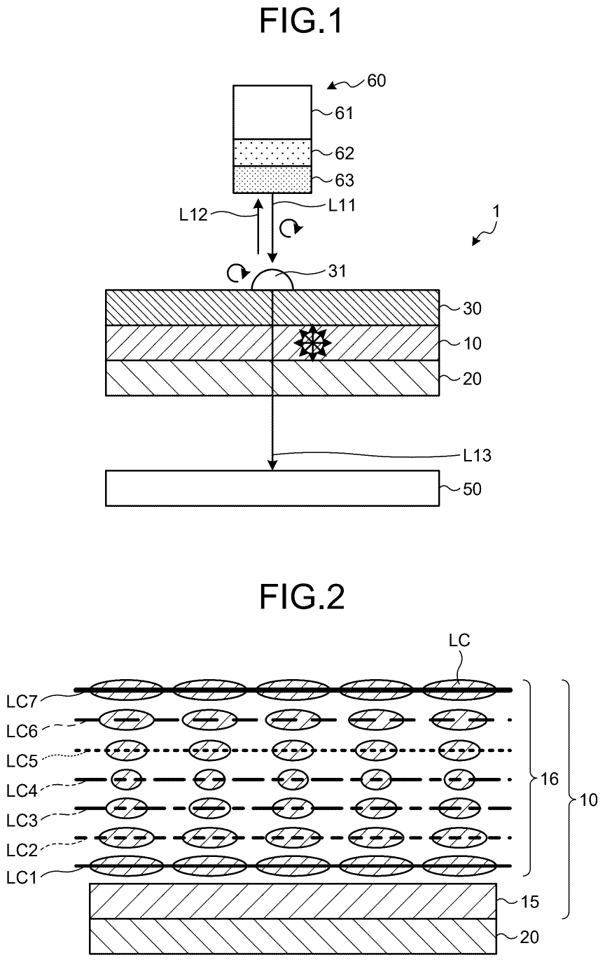

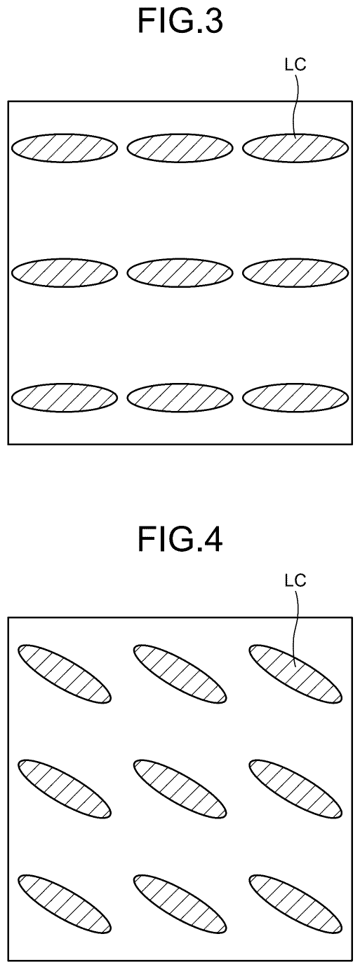

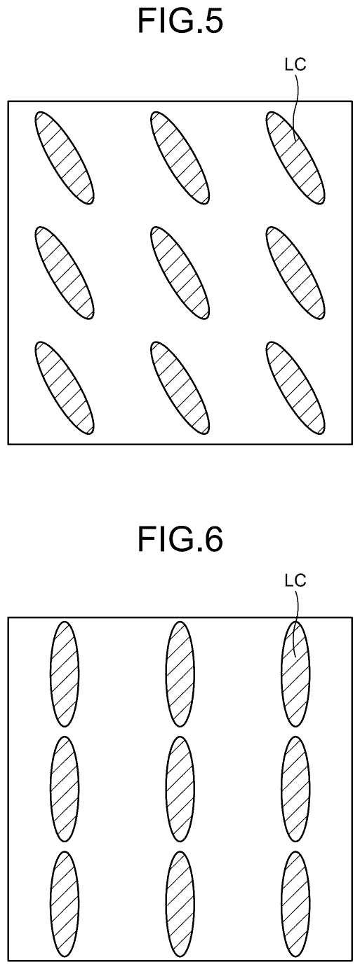

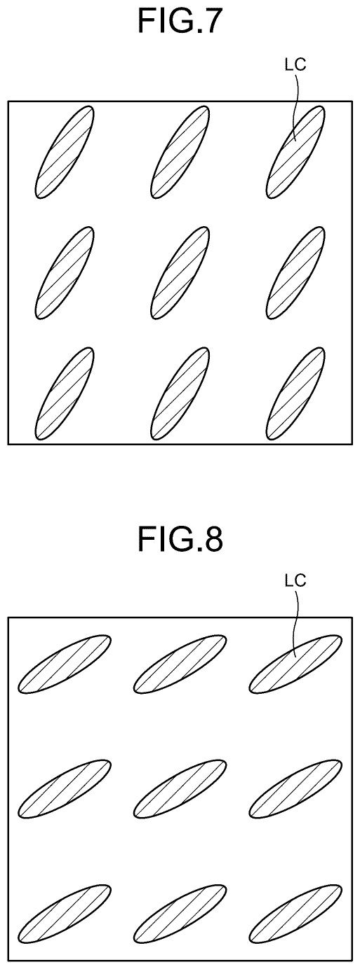

FIG. 1 is a schematic of a fluorescence detection device according to a first embodiment. FIG. 2 is a sectional view schematically illustrating a cholesteric liquid crystal layer according to the first embodiment. FIG. 3 is a plan view schematically illustrating a first layer and a seventh layer of the cholesteric liquid crystal layer according to the first embodiment. FIG. 4 is a plan view schematically illustrating a second layer of the cholesteric liquid crystal layer according to the first embodiment. FIG. 5 is a plan view schematically illustrating a third layer of the cholesteric liquid crystal layer according to the first embodiment. FIG. 6 is a plan view schematically illustrating a fourth layer of the cholesteric liquid crystal layer according to the first embodiment. FIG. 7 is a plan view schematically illustrating a fifth layer of the cholesteric liquid crystal layer according to the first embodiment. FIG. 8 is a plan view schematically illustrating a sixth layer of the cholesteric liquid crystal layer according to the first embodiment. As illustrated in FIG. 1, a fluorescence detection device 1 includes a light source 60, a cholesteric liquid crystal layer 10, a light-transmitting substrate 20, a sample holder 30, and a detection circuit 50 in a light-blocked space.

When the fluorescence detection device 1 irradiates a sample 31 with excitation light L11 of a predetermined wavelength, the substance in the sample 31 is excited and emits fluorescence L13 having spectral characteristics the peak wavelength of which slightly deviates from the wavelength of the excitation light. The fluorescence detection device 1 enables observing the intensity of the fluorescence L13 and the emission intensity distribution of the fluorescence L13.

The light-transmitting substrate 20 is an insulating base material and is made of glass or resin material, for example.

In the cholesteric liquid crystal layer 10, a liquid crystal layer 16 is formed on the light-transmitting substrate 20 with an orientation film 15 interposed therebetween. The orientation film 15 is made of polyimide or the like and is subjected to rubbing or photo-orientation treatment. In a cholesteric liquid crystal, elongated liquid crystal molecules are arranged with their long axes aligned in the same direction in one plane, and liquid crystal molecules LC helically rotate when viewed from a direction perpendicular to the plane of the light-transmitting substrate 20. Specifically, in a first layer LC1, a second layer LC2, a third layer LC3, a fourth layer LC4, a fifth layer LC5, a sixth layer LC6, and a seventh layer LC7 illustrated in FIG. 2, the liquid crystal molecules LC rotate as illustrated in FIGS. 3 to 8. The directions of the long axes of the liquid crystal molecules LC are aligned every ½ of a pitch p of the helix. Therefore, the long axis direction of the liquid crystal molecules LC in the first layer LC1 is the same as that of the liquid crystal molecules LC in the seventh layer LC7 as illustrated in FIG. 3.

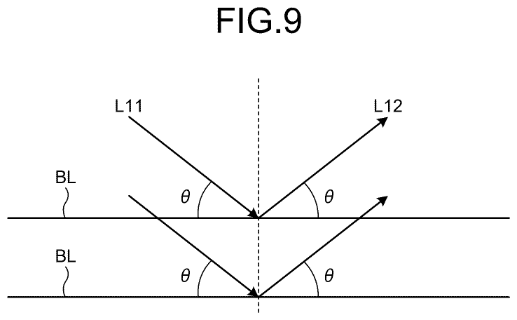

FIG. 9 is a diagram for explaining the relation between excitation light and reflected light. In the cholesteric liquid crystal layer 10, the cholesteric liquid crystal reflects light of a predetermined wavelength having circularly polarized light in the same rotation direction as that of the helix. As illustrated in FIG. 9, the excitation light L11 incident on the cholesteric liquid crystal layer 10 is reflected according to the same conditions as Bragg's law expressed by Expression (1).

$$2 \times ( p / 2 ) \times n \times sin θ = m \times λ \qquad ( 1 )$$

where m is the reflection order, λ is the reflection wavelength, p is the pitch of the helix, n is the refractive index, and θ is the angle formed by the incident direction of the excitation light with respect to a reflection surface BL.

The sample holder 30 is a light-transmitting component on which the sample 31 is placed. The sample holder 30 is preferably made of transparent material that does not emit fluorescence, such as silicon nitride (SiN). The sample holder 30, however, is not necessarily provided in the present embodiment.

The light source 60 includes a light emitter 61, a polarizing plate 62, and a quarter-wave plate 63. The light emitter 61 is a light-emitting element that oscillates and outputs predetermined excitation light. The polarizing plate 62 causes the light from the light emitter 61 to be in a linearly polarized state. The quarter-wave plate 63 converts the light from the polarizing plate 62 into the excitation light L11 in a circularly polarized state.

The detection circuit 50 is a charge coupled device and serves as an imaging circuit. The detection circuit 50 is capable of detecting the intensity of fluorescence and the emission intensity distribution of fluorescence.

As illustrated in FIG. 9, the excitation light L11 incident from the light source 60 is selectively reflected according to Bragg's law as reflected light L12. For example, if a plurality of liquid crystal molecules rotate clockwise, the cholesteric liquid crystal layer 10 reflects right-handed circularly polarized light having a wavelength corresponding to the pitch p out of the excitation light L11 as the reflected light L12. By contrast, if a plurality of liquid crystal molecules rotate counterclockwise, the cholesteric liquid crystal layer 10 reflects left-handed circularly polarized light having a wavelength corresponding to the pitch p out of the excitation light L11 as the reflected light L12.

The cholesteric liquid crystal layer 10 is produced by selecting a liquid crystal material and a chiral agent corresponding to the wavelength of the excitation light.

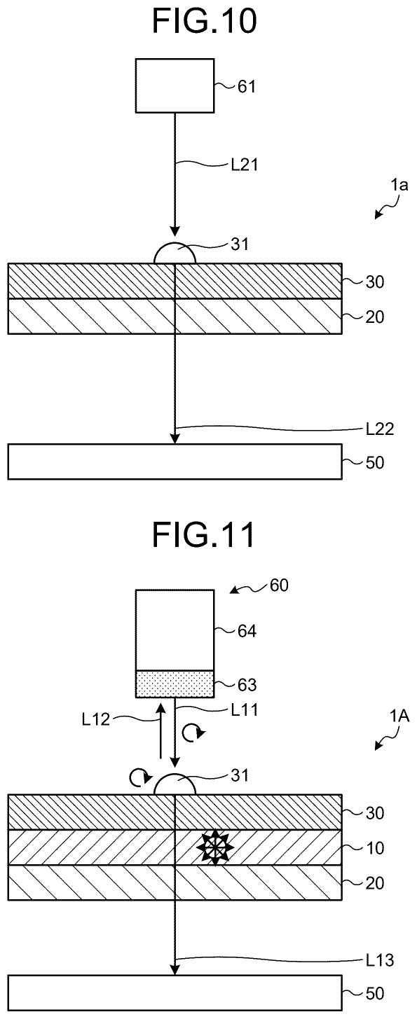

FIG. 10 is a schematic of the fluorescence detection device according to a comparative example. A fluorescence detection device 1a according to the comparative example illustrated in FIG. 10 does not include the cholesteric liquid crystal layer 10 compared with the fluorescence detection device 1 illustrated in FIG. 1. In the fluorescence detection device 1a according to the comparative example illustrated in FIG. 10, the sample holder 30 is stacked on the light-transmitting substrate 20.

When the fluorescence detection device 1a according to the comparative example irradiates the sample 31 with excitation light L21 of a predetermined wavelength, the substance in the sample is excited and emits fluorescence having spectral characteristics the peak wavelength of which slightly deviates from the wavelength of the excitation light. In the fluorescence detection device 1a, fluorescence L22 containing noise of the excitation light reaches the detection circuit 50.

By contrast, in the fluorescence detection device 1 according to the first embodiment, the cholesteric liquid crystal layer 10 selectively reflects the excitation light L11 as the reflected light L12.

As described above, the fluorescence detection device 1 according to the first embodiment includes the light source 60, the cholesteric liquid crystal layer 10, and the detection circuit. The light source 60 irradiates the sample 31 with the excitation light L11 in a circularly polarized state. The cholesteric liquid crystal layer 10 causes the fluorescence L13 emitted by the sample 31 due to the excitation light L11 to transmit therethrough and reflects the excitation light L11. The detection circuit detects the fluorescence L13 transmitted through the cholesteric liquid crystal layer 10. Therefore, the excitation light L11 can be selectively reflected as the reflected light L12, and the excitation light L11 that reaches the detection circuit 50 is reduced. As a result, the detection sensitivity for the fluorescence L13 detected by the detection circuit 50 is improved.

### Second Embodiment

FIG. 11 is a schematic of the fluorescence detection device according to a second embodiment. In the following description, the same components as those described in the embodiment above are denoted by the same or similar reference numerals, and duplicated explanation is omitted.

A fluorescence detection device 1A includes the light source 60, the cholesteric liquid crystal layer 10, the light-transmitting substrate 20, the sample holder 30, and the detection circuit 50 in a light-blocked space.

As illustrated in FIG. 11, in the fluorescence detection device 1A according to the second embodiment, the light source 60 includes a light emitter 64 and the quarter-wave plate 63. The light emitter 64 outputs laser light in a linearly polarized state. The quarter-wave plate 63 converts light from the light emitter 64 into the excitation light L11 in a circularly polarized state.

### Third Embodiment

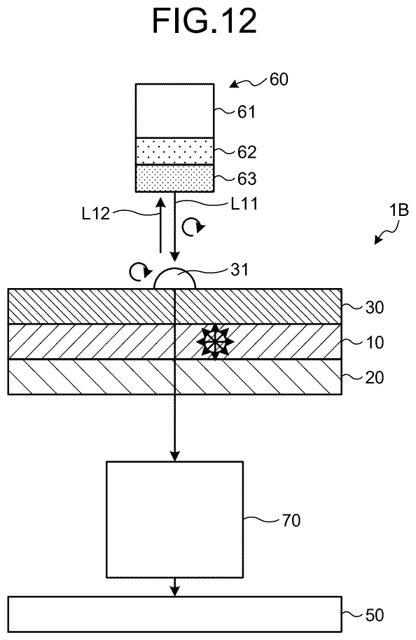

FIG. 12 is a schematic of the fluorescence detection device according to a third embodiment. In the following description, the same components as those described in the embodiments above are denoted by the same or similar reference numerals, and duplicated explanation is omitted.

A fluorescence detection device 1B includes the light source 60, the cholesteric liquid crystal layer 10, the light-transmitting substrate 20, the sample holder 30, the detection circuit 50, and a lens 70 in a light-blocked space. As illustrated in FIG. 12, the fluorescence detection device 1B according to the third embodiment further includes the lens 70 provided between the cholesteric liquid crystal layer 10 and the detection circuit 50 to condense the fluorescence emitted from the sample 31.

Thus, the efficiency of collecting the fluorescence L13 is improved by the lens 70.

### Fourth Embodiment

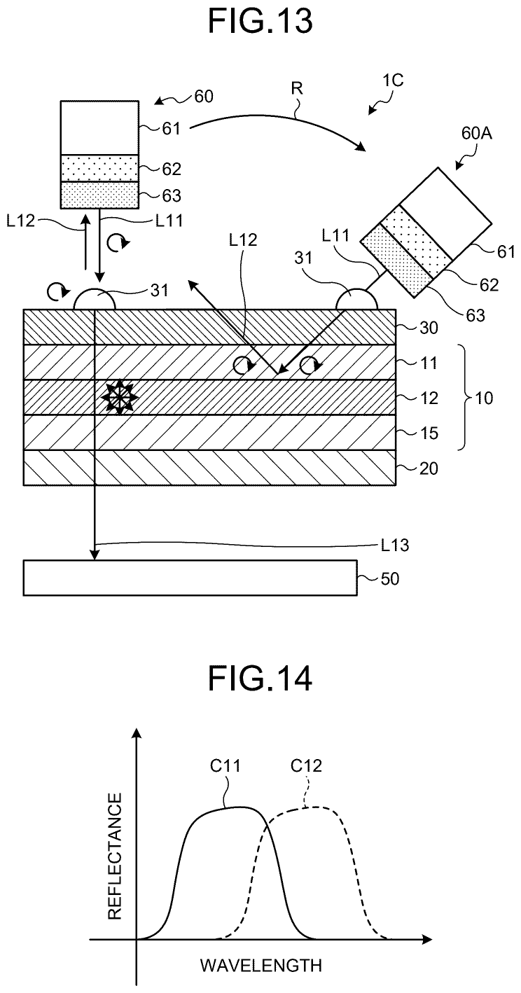

FIG. 13 is a schematic of the fluorescence detection device according to a fourth embodiment. FIG. 14 is a diagram for explaining the relation between the wavelength characteristics of excitation light reflected by a first liquid crystal layer and the wavelength characteristics of excitation light reflected by a second liquid crystal layer according to the fourth embodiment. In the following description, the same components as those described in the embodiments above are denoted by the same or similar reference numerals, and duplicated explanation is omitted.

As described above, in the fluorescence detection device 1 according to the first embodiment, the excitation light L11 incident from the light source 60 is selectively reflected by the cholesteric liquid crystal layer 10 according to Bragg's law as the reflected light L12. Therefore, if the angle of incidence from the light source 60 is shifted, the excitation light L11 is more likely to enter the detection circuit 50. By contrast, a fluorescence detection device 1C according to the fourth embodiment includes a plurality of liquid crystal layers having different reflection bands. Therefore, if the angle of incidence of the excitation light L11 is slightly inclined, the fluorescence detection device 1C can reflect the excitation light L11 and expand the secured range of the angle of incidence of the excitation light L11.

The fluorescence detection device 1C includes the light source 60, the cholesteric liquid crystal layer 10, the light-transmitting substrate 20, the sample holder 30, and the detection circuit 50 in a light-blocked space. Specifically, the cholesteric liquid crystal layer 10 according to the fourth embodiment includes a first liquid crystal layer 11 having a first pitch of the helix and a second liquid crystal layer 12 having a second pitch of a helix different from the first pitch. The second liquid crystal layer 12 is formed on the orientation film 15. The first liquid crystal layer 11 is formed on the second liquid crystal layer 12. The first pitch of the helix of the first liquid crystal layer 11 is made different from the second pitch of the helix of the second liquid crystal layer 12 by varying the chiral agent or other material. As illustrated in FIG. 14, the wavelength of the wavelength characteristic C11 of the excitation light reflected by the first liquid crystal layer 11 deviates from that of the wavelength characteristic C12 of the excitation light reflected by the second liquid crystal layer 12. The cholesteric liquid crystal layer 10 may include three or more liquid crystal layers having different pitches of the helix from one another.

For example, if the position of the light source 60 is shifted to a position of a light source 60A rotated in a direction R from the position of the light source 60 as illustrated in FIG. 13, the second liquid crystal layer 12 fails to reflect the excitation light L11 from the light source 60A, but the first liquid crystal layer 11 can reflect the excitation light L11 from the light source 60A.

While exemplary embodiments according to the present disclosure have been described, the embodiments are not intended to limit the disclosure. The contents disclosed in the embodiments are given by way of example only, and various modifications can be made without departing from the spirit of the present disclosure. Appropriate modifications made without departing from the spirit of the present disclosure should naturally fall within the technical scope of the disclosure. At least one of various omissions, substitutions, and modifications of the components can be made without departing from the gist of the embodiments and modifications described above.

What is claimed is:

1. A fluorescence detection device comprising:
a light source configured to irradiate a sample with excitation light in a circularly polarized state;
a cholesteric liquid crystal layer configured to cause fluorescence emitted by the sample due to the excitation light to transmit therethrough and reflect the excitation light; and
detection circuitry configured to detect the fluorescence transmitted through the cholesteric liquid crystal layer.

2. The fluorescence detection device according to claim 1, wherein the light source comprises a light emitter, a polarizing plate configured to cause light from the light emitter to be in a linearly polarized state, and a quarter-wave plate configured to convert the light in the linearly polarized state output from the polarizing plate into the excitation light in the circularly polarized state.

3. The fluorescence detection device according to claim 1, further comprising a light-transmitting substrate on which the cholesteric liquid crystal layer is formed.

4. The fluorescence detection device according to claim 1, wherein the cholesteric liquid crystal layer comprises a first liquid crystal layer having a first pitch of a helix and a second liquid crystal layer having a second pitch of a helix different from the first pitch.

5. The fluorescence detection device according to claim 1, further comprising a lens provided between the cholesteric liquid crystal layer and the detection circuitry and configured to condense the fluorescence.
